(19) United States
(12) Patent Application Publication
(10) Pub. No.: US 2005/0216400 A1
(43) Pub. Date: Sep. 29, 2005

(54) System and method of managing payments

(76) Inventors: Daniel Francis Doyle, Oyster Bay, NY (US); David Lee Endrody, Wheaton, IL (US); Danielle Maureen Jirsa, Cardiff-by-the Sea, CA (US); Carlos Ricardo Whiteman, Chicago, IL (US)

Correspondence Address: MCDERMOTT, WILL & EMERY LLP, 227 WEST MONROE STREET, CHICAGO, IL, 60606-5096, US

(21) Appl. No.: 11/041,810

(22) Filed: Jan. 21, 2005

Related U.S. Application Data
(60) Provisional application No. 60/538,883, filed on Jan. 22, 2004.

(51) Int. Cl. G06F 17/60

(52) U.S. Cl. 705/39

(57) ABSTRACT

The present subject matter discloses a method of managing payments made in the construction industry. A subcontractor delivers an invoice to the builder, the builder approves the invoice and forwards the invoice to a title company. The title company verifies the builder has the requisite funds in a construction loan or line of credit held by the builder and the title company requests a lien waiver from the subcontractor. When the title company receives confirmation of the builder's available funds and the lien waiver from the subcontractor, the title company processes a payment voucher, communicates the approved payment amount to the subcontractor and provides the subcontractor access to the approved payment through the builder's transaction account.

### CROSS-REFERENCE TO RELATED APPLICATIONS

The present application claims the benefit of U.S. Provisional Application Ser. No. 60/538,883 filed Jan. 22, 2004, the disclosure of which is entirely incorporated herein by reference.

### TECHNICAL FIELD

The present subject matter relates to a system and method of providing the construction industry with a new system and method of doing business with subcontractors, vendors, suppliers, customers and employees. More specifically, the present subject matter relates to a system for and method of providing a transaction account for managing payments in the construction industry.

### BACKGROUND

In the construction industry, contractors, such as home builders, hired subcontractors to perform various construction functions. For example, it was typical for a subcontractor to be responsible for purchasing construction items ranging from electrical fittings to plumbing materials and the like. Often the costs associated with the purchases made by the subcontractors were to ultimately be paid by the contractor. However, in practice it was common for subcontractors to make the requisite purchases and then later request reimbursement from the contractor. Moreover, the contractor also paid the subcontractor for work performed. In many cases, payment from the contractor to the subcontractor was not efficiently transacted.

### SUMMARY

The present subject matter discloses a system and method of managing payments made in the construction industry. For example, the payments may be made between a contractor and a subcontractor. Specifically, a contractor may provide payment to a subcontractor from a transaction account. After making an expenditure, a subcontractor delivers an invoice requesting payment from the contractor. The contractor approves the invoice and forwards the invoice to a title company. Next, the title company verifies funds are available from a construction loan or line of credit held by the contractor and requests a lien waiver from the subcontractor. When the subcontractor supplies the lien waiver to the title company and the title company has verified the finds are available for the contractor to make payment, the title company processes a payment voucher, communicates the approved payment amount to the subcontractor and provides the subcontractor access to the approved payment through the contractor's transaction account. The system and method of the present invention may be applicable to contractors, subcontractors, vendors, suppliers, customers and employees. The system and method may be applied to other industries and people as well.

An objective is to provide a system and method of managing payments between contractors and subcontractors using transaction accounts.

It is a further objective to provide a system and method of managing a transaction account for use in providing payment to subcontractors.

Another objective is to provide a system and method of efficiently managing payments between two entities wherein the payments are made from a loan associated with a transaction account.

Additional objects, advantages and novel features of the examples will be set forth in part in the description which follows, and in part will become apparent to those skilled in the art upon examination of the following and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF DRAWINGS

The drawing figures depict one or more implementations in accord with the present concepts, by way of example only, not by way of limitations. In the figures, like reference numerals refer to the same or similar elements.

FIG. 1 is a flow chart depicting a method of managing payments.

FIG. 2 is a schematic of a system of the present invention.

### DETAILED DESCRIPTION

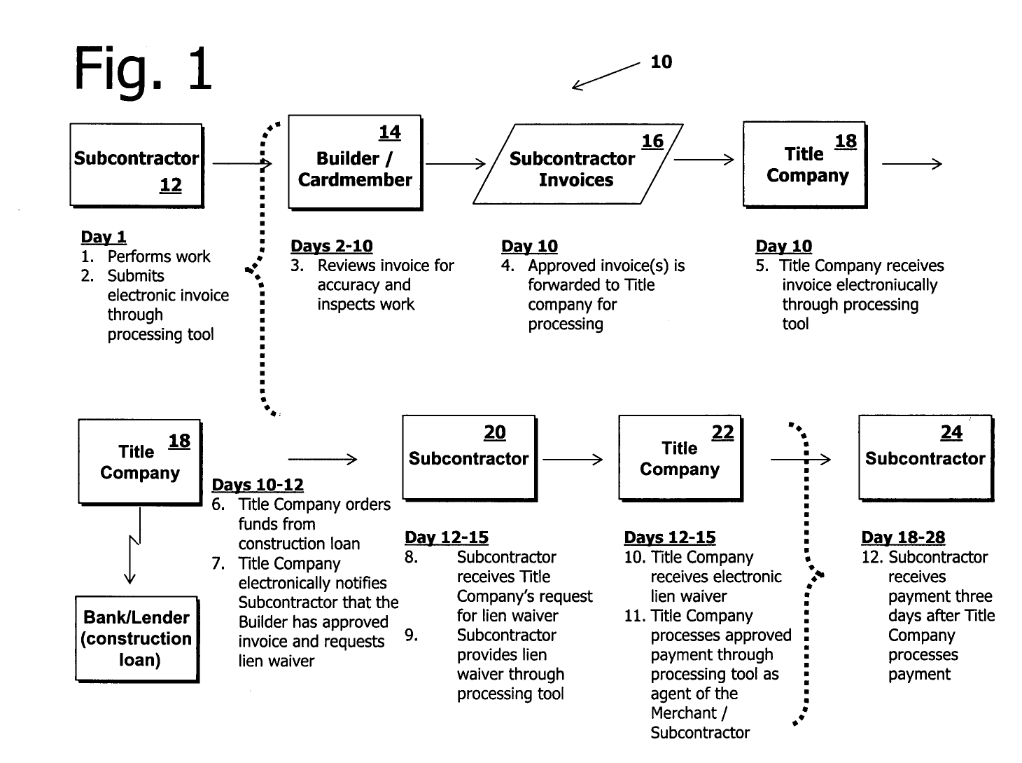

FIG. 1 illustrates a method 10 of the present invention. As shown in FIG. 1, the method 10 provides a process for managing payment from a contractor to a subcontractor for approved expenditures made by the subcontractor. Although the method 10 shown in FIG. 1 relates specifically to a contractor's reimbursement of expenditures made by a subcontractor, the method 10 is equally applicable to contractors, subcontractors, vendors, suppliers, customers and employees. Further, the invention of the present invention may be applicable in other industries beyond the construction industry.

In the example shown in FIG. 1, the contractor is a builder that has a transaction account for making payments. The transaction account may be a credit account, such as a credit account provided for use with a transaction card, such as a credit card. The transaction account may otherwise be a revolving line of credit or other account from which payment to a subcontractor may be made.

As shown in FIG. 1, a subcontractor performs a service for which payment from the builder is due. The method 10 includes a first step 12 wherein the subcontractor provides an invoice to the builder for the requested funds to be paid from the builder's transaction account. The invoice may be for services, expense or a combination of services and expenses. The method 10 includes a second step 14 wherein the builder reviews the invoice, resolves any questions the builder has with the subcontractor relating to the requested funds, the services performed or the expenses incurred. When the invoice is approved, the builder forwards the approved invoice to a third party, such as a title company, for processing of the requested funds via a third step 16. The third step 16 may include grouping a number of invoices received from the subcontractor together for more efficient payment of a number of related invoices. The title company receives the invoice and orders the requested funds from an existing construction loan via a fourth step 18. The fourth step 18 ensures the builder has the funds required to make the approved payments. Under the method 10 shown in FIG. 1 the title company may be solely liable for the transactions processed via the method 10. In the method 10 shown in FIG. 1, the title company further sends a notice to the subcontractor that the builder has approved the invoice and requests a lien waiver from the subcontractor via the fourth step 18.

In a fifth step 20 of the method 10, upon receipt of the title company's lien waiver request, the subcontractor sends a lien waiver to the title company. When the title company receives the lien waiver from the subcontractor, the title company processes a payment voucher, communicates the approved payment amount to the subcontractor and provides the subcontractor access to the approved payment through the builder's transaction account via a sixth step 22. In the final step 24 of the method 10 shown in FIG. 1, the subcontractor is paid via the builder's transaction account.

Under the method 10 shown in FIG. 1, payment of the requested funds is only authorized by the title company when the title company receives both a lien waiver from the subcontractor and receives confirmation that the requested funds are available from the builder. Accordingly, the method 10 safeguards against disputes arising from a builder's inability to pay and the subcontractor's refusal or failure to release the builder's debt.

The method 10 shown in FIG. 1, may follow the timeline illustrated in FIG. 1, i.e., the final step 24 may occur approximately twenty-eight days after the first step 12 of the method 10. Alternatively, the method 10 may occur according to a different timeline comprising either a shorter or a longer period of time.

As described above, the approved payments made by the builder correspond to pre-approved bank construction loans and lines of credit accessed by the title company. The third party or title company acts as an escrow agent to facilitate the payment process from the builder to the subcontractor.

The steps of the method 10 may be automated via computer systems utilizing the Internet or using other “online technology” to enable electronic transfer of invoices and other communications involved in the method 10. Electronic transfer of communications may enable automated invoice approvals and payments, may reduce the number of invoices that must be subjectively reviewed (enabling managers of the communications to “manage by exception”), may prevent duplicative communications and may enable online dispute resolution. Electronic transfers may also improve the payment cycle time, reduce the billing process costs, improve invoice control and visibility and may allow the posting of invoices from various electronic systems, such as, for example, existing accounting programs. Those of ordinary skill in the art will readily recognize that the functions and capabilities of the method 10 of the present invention can be implemented on one or more machines or computers in a network, which may use one or more computer platforms.

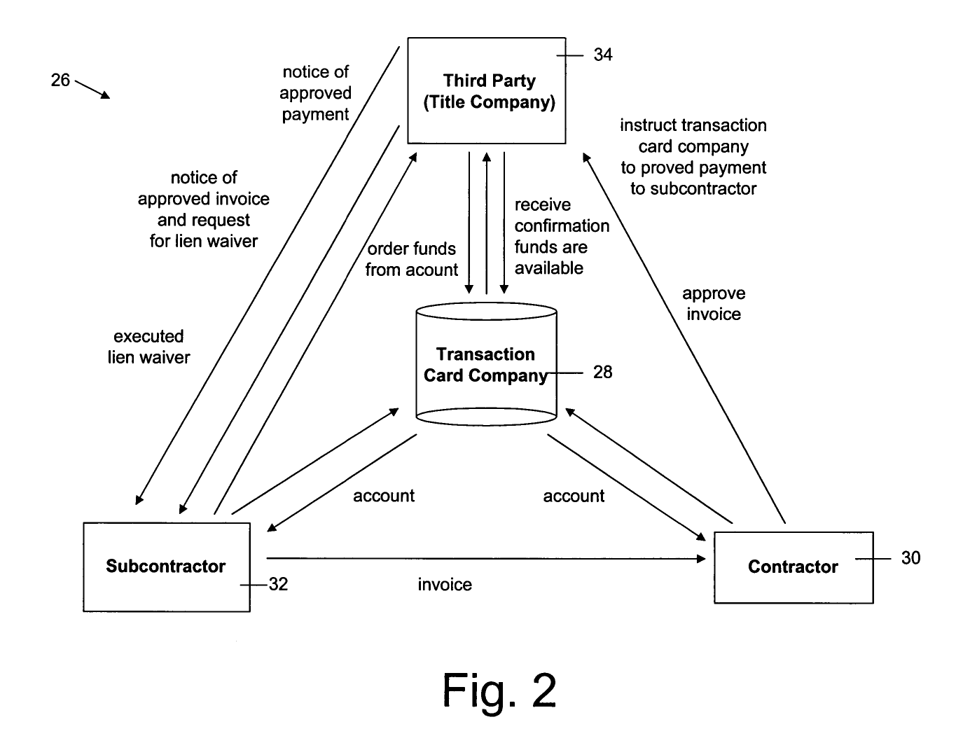

For example, FIG. 2 illustrates a system 26 for implementing the method 10 described with respect to FIG. 1. As shown in FIG. 2, within the system 26 a transaction card company 28 has established relationships with a contractor 30 and a subcontractor 32. For example, the contractor 30 and subcontractor 32 may have transaction card accounts with the transaction card company 28. As shown in FIG. 2, the subcontractor 32 provides an invoice to the contractor 30. If the contractor 30 approves the invoice, the contractor 30 notifies a third party 34, for example, a title company, that the invoice has been approved. The third party 34 then orders the funds required to pay the invoice from the transaction card company 28, as shown in FIG. 2. The third party 34 also notifies the subcontractor 32 the invoice has been approved, the funds have been ordered from the transaction card company 34 and requests a lien waiver from the subcontractor 32. The subcontractor 32 then provides a lien waiver to the third party 34, who in turn processes the lien waiver and authorizes payment of the invoice by the contractor 30 through the transaction card company 28, receives confirmation the finds are available from the contractor 30 through the transaction card company 28 and provides notice to the subcontractor 32 of the approved payment. After the transaction card company 28 receives the authorization for payment of the invoice from the third party 34, the transaction card company 28 completes the transaction by crediting the transaction card account of the subcontractor 32.

The system 26 shown illustrated in FIG. 2 may be employed through a computer network in which various portions of the system are automated. For example, in response to receiving an approved invoice, the third party 34 may automatically provide the subcontractor 32 with the notice of approved invoice and a request for a lien waiver. Similarly, other portions of the system 26 may be automated using a computer, a computer network or other electronic means.

As discussed above, payments made by the contractor in the system 26 and the method 10 may be made from a transaction card account. Accordingly, the contractor may earn reward points or bonuses from the company providing the transaction card account. The contractor may then use those points or rewards for employee incentives, buyer incentives, bonuses, gifts, promotions, etc. When payment is made from a transaction card account, the subcontractor may benefit by receiving a quicker, easier and more efficient payment process, the subcontractor will not have to deal with tracking checks and the payment issues involved with check cashing. The third party that processes the payment voucher may benefit from an expanded customer list and from the simpler lower cost process provided by the system 26 and the method 10. The transaction card account company may benefit from a significant new source of transaction volume, a minimal credit risk and minimal marketing expenses.

The transaction card accounts used in conjunction with the system 26 and the method 10 shown in FIGS. 1 and 2 may be part of a closed loop system wherein each entity requesting payment through the system 26 and the method 10 must be registered as a “merchant.” For example, in order for a subcontractor to receive payment from a contractor's transaction card account, the subcontractor must be enabled to receive payment within the system by being given a merchant code that identifies the subcontractor as a merchant within the context of the system 26 and the method 10. Only payments made to merchants having the proper merchant code may completed within the system 26 and the method 10. Accordingly, if the contractor's transaction card account is fraudulently used in an attempt to purchase goods from a merchant not registered within the system 26 and the method 10 (for example, to buy airline tickets), the transaction will not be approved. The closed loop system provides security against fraud for the transaction card account holder, the transaction card account provider and merchants, both those registered within the system 26 and the method 10 and those outside of the system 26 and the method 10.

A general purpose computer may be used to execute computer or machine readable instructions and carryout or perform desired steps or functions of the system 26 and method 10. As is known to those of ordinary skill in the art, a general-purpose computer typically comprises a central processor, an internal communication bus, various types of memory (RAM, ROM, EEPROM, cache memory, etc.), disk drives or other code and data storage systems, and one or more network interface cards or ports, and sound cards for communication purposes. The computer and computer system may also use a relatively high-speed communication interface to an external network.

Moreover, software functionalities involve programming, including executable code as well as associated stored data. The software code is executable by the general-purpose computers or processors that can functions as part of the securities account monitoring system. In operation, the executable program code or software and associated data can be stored in an appropriate memory or data storage locations and/or transported for loading into appropriate general-purpose computing machines. In one aspect, the present subject matter involves one or more software products and applications in the form of one or more modules of code carried by at least one machine-readable medium. Execution of such code by one or more processors of the computer platform enables implementation and operation of the system 26 and the method 10 of the present invention.

As used herein, terms such as computer or machine “readable medium” refer to any medium that participates in providing instructions to a processor for execution. Such a medium may take many forms, including but not limited to, non-volatile media, volatile media, and transmission media. Non-volatile media include, for example, optical or magnetic disks, such as any of the storage devices in a computer or machine. Volatile media include dynamic memory, such as main memory of such a computer. Physical transmission media include coaxial cables, copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media include, for example: a floppy disk, a flexible disk, hard disk, magnetic tape, any other magnetic medium, a CD-ROM, DVD, any other optical medium, punch cards, paper tape, any other physical medium with hole patterns, a RAM, a PROM, and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the technology and subject matter disclosed herein may be implemented in various forms and examples, and that they may be applied in numerous applications, only some of which have been described herein. Those skilled in that art will recognize that the disclosed aspects may be altered or amended without departing from the true spirit and scope of the subject matter. Therefore, the subject matter is not limited to the specific details, representative devices, and illustrated examples in this description. It is intended to protect any and all modifications and variations that fall within the true scope of the advantageous concepts disclosed herein.

1. A method of managing payments comprising the steps of:
providing a loan to a first entity, wherein said loan is associated with a transaction account and serviced by a loan servicing entity;
providing an invoice to the loan servicing entity requesting payment to a second entity from the loan associated with the transaction account; and
providing payment to the second entity from the loan associated with the transaction account.

2. The method of claim 1 further comprising the step of the loan servicing entity requesting a lien waiver from the second entity.

3. The method of claim 2 further comprising the step of receiving the lien waiver from the second entity before the step of providing payment to the second entity form the loan associated with the transaction account.

4. The method of claim 1 wherein said step of providing an invoice to the loan servicing entity requesting payment to a second entity from the loan associated with the transaction account further comprises providing the invoice to the first entity and the first entity then providing the invoice to the loan servicing entity.

5. The method of claim 1 wherein said transaction account is a credit account.

6. The method of claim 1 wherein said loan servicing entity is an escrow agent.

7. The method of claim 1 wherein said loan servicing entity is a title company.

8. The method of claim 1 wherein said first entity is a builder.

9. The method of claim 1 wherein said second entity is a subcontractor.

10. A system for managing payments made between a first entity and a second entity from finds associated with a transaction account and serviced by a third entity including:
means for receiving a request that payment be made to the second entity from the funds associated with the transaction account;
means for receiving a lien waiver from the second party; and
means for generating instructions to authorize payment to the second entity from the funds associated with the transaction account.

11. The system of claim 10 further comprising means for requesting a lien waiver from the second party.

12. The system of claim 10 wherein the transaction account is a credit account.

13. The system of claim 10 wherein the second party is a subcontractor.

14. An apparatus for managing payments comprising:
means for receiving a request to make payment from a transaction card account to a first party;
means for requesting a lien waiver from said first party in response to receiving said request to make payment to said first party;
means for receiving a lien waiver from said first party in response to a request for said lien waiver; and
means for generating instructions authorizing payment to said first party from said transaction card account in response to receiving said lien waiver from said first party.

15. The apparatus of claim 14 wherein the transaction card account is a credit card account.

16. The apparatus of claim 14 wherein said first party is a subcontractor.

17. The apparatus of claim 14 wherein said transaction card account belongs to a contractor.

18. The apparatus of claim 14 wherein said apparatus further comprises a networked computer.

19. The apparatus of claim 14 wherein said transaction card account is associated with a construction loan.

20. The apparatus of claim 14 further comprising means for communicating an approved payment amount to said first party in response to receiving said waiver from said first party.
